(19) United States
(12) Patent Application Publication
(10) Pub. No.: US 2026/0106934 A1
(43) Pub. Date: Apr. 16, 2026

(54) TELEPHONE SCAM PROTECTION SYSTEM BASED ON ARTIFICIAL INTELLIGENCE

(71) Applicants: CHAO-HUNG LIN, New Taipei City (TW); Farxun Wisdom INC., New Taipei City (TW)

(72) Inventor: CHAO-HUNG LIN, New Taipei City (TW)

(21) Appl. No.: 19/354,682

(22) Filed: Oct. 9, 2025

(30) Foreign Application Priority Data
Oct. 11, 2024 (TW) 113138834

(51) Int. Cl. H04M 3/22; G06V 10/70; G06V 30/19; G10L 15/08; G10L 15/18

(52) U.S. Cl. CPC H04M 3/2281; G10L 15/1815; G06V 10/70; G06V 30/19; G10L 2015/088

(57) ABSTRACT

An artificial intelligence (AI)-based system designed to prevent telephone fraud communications is provided. When a user is unable to answer or a caller is unidentified, the system automatically answers the call and verifies the caller's identity through real-time conversation using natural language processing and semantic analysis. The system dynamically analyzes conversation content to detect potential fraud or phishing activities and classifies the call into risk categories such as safe, suspicious, or dangerous. Based on the classification, the system executes appropriate operations, such as providing conversation summaries, recording suspicious calls for further analysis, or terminating and blocking dangerous calls while reporting the event to governmental authorities. The system may be integrated with external services, such as calendars and messaging platforms, to automatically schedule events and efficiently manage communications. The user can monitor the conversation in real time and intervene when necessary, thereby ensuring both the security and control of call interactions.

### FIELD OF THE INVENTION

The present invention relates to telecommunication and security technologies, and more particularly to systems and methods utilizing artificial intelligence (AI) and machine learning techniques to prevent telephone fraud.

### BACKGROUND OF THE INVENTION

With the widespread adoption of telecommunication technologies, the volume of telephone interactions has increased significantly, encompassing both personal and business communications. However, this growth has also been accompanied by a rise in fraudulent activities, such as phishing, caller ID spoofing, and other deceptive practices intended to manipulate individuals or organizations for illicit gain.

Conventional call-handling systems, including caller ID and call-blocking services, primarily rely on databases of known scam numbers or patterns to identify and reduce unwanted or malicious calls. These systems typically filter calls based on predefined criteria and do not engage in real-time analysis or verification of the caller's intent. As a result, they are often ineffective against sophisticated or novel scams that do not conform to known signatures or patterns.

Telephone fraud continues to pose significant risks to both individuals and organizations, resulting in financial losses, disclosure of personal information, and erosion of trust in telecommunication services. While existing solutions provide some benefits, they are inadequate in addressing the complexity and constantly evolving nature of modern scams. Accordingly, there is a clear need for an intelligent, proactive, and integrated approach to preventing telephone fraud, one that provides comprehensive protection against a wide range of fraudulent activities.

### SUMMARY OF THE INVENTION

The present invention provides a system and method for preventing telephone fraud by utilizing advanced artificial intelligence technologies. The system comprises several key components, including a communication interface, an AI module, an audio output interface, a user intervention interface, a data storage component, and an integration module.

The communication interface is configured to receive and transmit telephone calls. When an incoming call is detected and the user is unavailable or the caller is unidentified, the AI module automatically answers the call on behalf of the user. The AI module employs natural language processing and semantic analysis to conduct real-time dialogue with the caller, verify the caller's identity, and assess the legitimacy of the call.

During the conversation, the AI module analyzes the content in real time to detect potential fraudulent activities by identifying suspicious keywords or scam-related patterns. Each call is classified into at least three risk categories: safe, suspicious, and dangerous. For calls classified as dangerous, the system automatically terminates the call, blocks the caller's number, and reports the event to governmental authorities.

The audio output interface enables the user to monitor ongoing conversations in real time, while the user intervention interface provides the ability for the user to intervene and override the actions taken by the AI module when necessary. The data storage component securely stores conversation summaries, classification data, and records of suspicious or dangerous calls using encryption to ensure privacy.

The integration module extracts relevant information from the conversations and integrates the information into external services, such as calendars and messaging platforms. This functionality allows events to be automatically scheduled in the user's calendar based on extracted information, thereby enhancing convenience and organizational efficiency.

In certain embodiments, when the system is used with VoIP or communication applications such as LINE, the AI module performs real-time phishing assessments of any URLs or websites mentioned by the caller by comparing them against known blacklists. The AI module may also analyze visual content provided by the caller using image recognition and optical character recognition (OCR) techniques. The AI module continuously updates its fraud detection algorithms based on past interactions and external threat intelligence sources, adjusting its operating parameters according to user feedback and detected patterns to improve accuracy.

The methods for preventing telephone fraud include steps executed by the various components of the system: receiving incoming calls, automatically answering calls, conducting real-time dialogue to verify the caller's identity, analyzing the conversation for potential fraud, classifying the call by risk, and taking appropriate actions based on the classification. These methods also include enabling user monitoring and intervention, securely storing relevant data, and integrating extracted information into external services. Overall, the invention combines real-time AI-driven call handling, advanced fraud detection technologies, user interaction functions, and tight integration with external services to provide a proactive and adaptive solution for preventing telephone fraud, while ensuring strong security and user privacy protection.

### BRIEF DESCRIPTION OF THE DRAWINGS

The accompanying drawings are provided to illustrate exemplary embodiments of the present invention and are not intended to limit the scope thereof. Identical reference numerals denote identical elements throughout the drawings.

FIG. 1A illustrates a block diagram of one embodiment of the telephone scam protection system according to the present invention.

FIG. 1B illustrates a block diagram of another embodiment of the telephone scam protection system according to the present invention.

FIG. 2A illustrates how the telephone scam protection system handles a safe incoming call.

FIG. 2B illustrates how the telephone scam protection system handles a suspicious incoming call.

FIG. 2C illustrates how the telephone scam protection system handles a dangerous incoming call.

FIG. 3A illustrates a flowchart of an operating procedure of the telephone scam protection system in a personal-use scenario.

FIG. 3B illustrates a flowchart of an operating procedure of the telephone scam protection system in an enterprise-use scenario.

### DESCRIPTION OF THE PREFERRED EMBODIMENTS

The present invention relates to a telephone scam protection system and method, which is an advanced system and method designed using artificial intelligence (AI) and machine learning techniques to prevent fraudulent telephone communications. The system can be seamlessly integrated into existing telecommunication infrastructures to provide real-time call handling, fraud detection, and user interaction functions. The telephone scam protection system is specifically designed to defend against various fraudulent activities, including phishing, caller ID spoofing, and social engineering attacks, thereby enhancing security at both personal and enterprise levels.

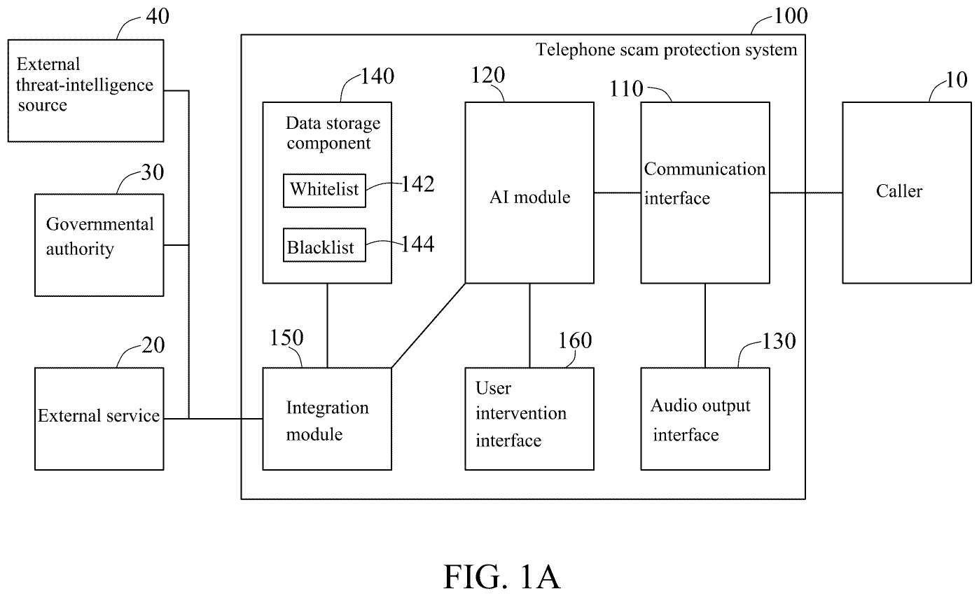

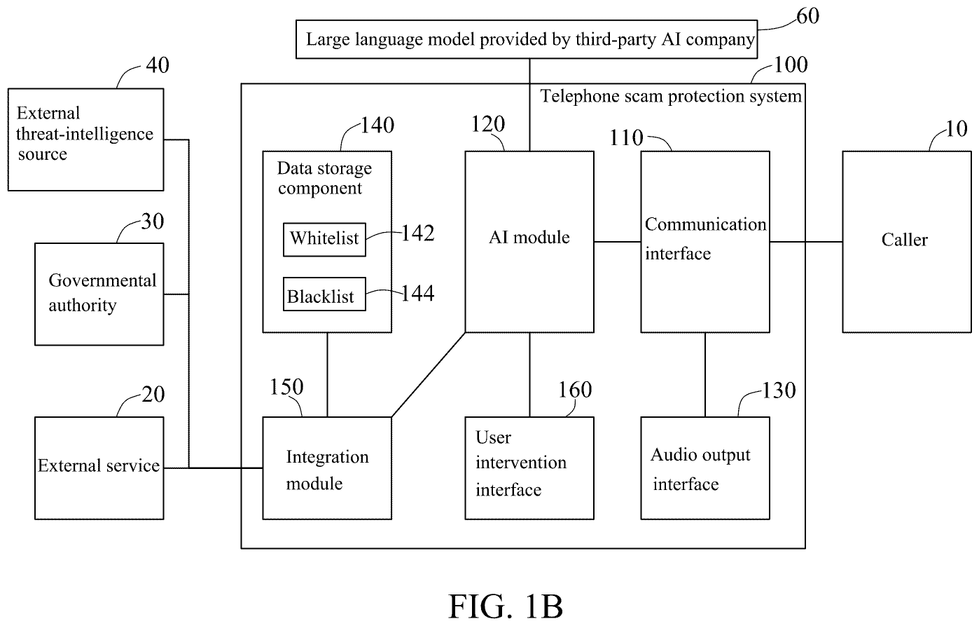

Referring to FIG. 1A, FIG. 1A illustrates a block diagram of one embodiment of the telephone scam protection system 100 according to the present invention. The system 100 includes multiple interconnected modules and components that cooperate to provide comprehensive fraud protection functions. The primary components include a communication interface 110, an artificial intelligence (AI) module 120, an audio output interface 130, a data storage component 140, an integration module 150, and a user intervention interface 160.

The communication interface 110 is responsible for receiving and transmitting telephone calls, allowing the telephone scam protection system 100 to interact with a caller 10 and a user. The AI module 120 is responsible for managing call interactions, performing fraud detection, and making decisions. The audio output interface 130 allows the user to monitor ongoing conversations through a hands-free device, thereby providing real-time situational awareness. The data storage component 140 securely stores conversation summaries, classification data, and records of suspicious or dangerous calls. The integration module 150 connects the telephone scam protection system 100 to external services 20 (such as calendars and messaging platforms) to achieve automated data synchronization. Finally, the user intervention interface 160 allows the user to override actions of the AI module 120 or directly participate in the conversation when necessary.

The telephone scam protection system 100 can operate as a standalone solution or be integrated into existing personal devices or enterprise-level telecommunication systems.

The core functionality of the telephone scam protection system 100 is its AI-based call handling function, which automates the management of incoming calls. When an incoming call is detected, the communication interface 110 establishes a connection with the caller 10. If the user is unavailable (e.g., while driving or in a meeting) or if the caller 10 is unidentified, the AI module 120 automatically answers the call on behalf of the user. During the call, the user may listen in real time via the audio output interface 130 (typically a hands-free device). This dual-channel communication ensures that the user remains informed of the interaction and has the flexibility to intervene or take over the call when necessary. The AI module 120 employs natural language processing (NLP) to conduct meaningful conversations with the caller 10, with the purpose of verifying the caller's identity and assessing the legitimacy of the call.

The telephone scam protection system 100 employs an advanced call analysis and classification method to evaluate incoming calls according to risk levels. The AI module 120 analyzes the conversation content in real time, using semantic analysis and keyword detection to identify potential fraudulent or phishing activities. Each incoming call is classified into one of three risk categories: safe, suspicious, or dangerous.

Referring to FIG. 1B, FIG. 1B illustrates another embodiment of the telephone scam protection system 100. To further enhance the capability of the AI module 120, in one embodiment, the system 100 is integrated with a large language model (LLM) 60 provided by a third-party AI company, such as OpenAI's GPT. This integration enables the telephone scam protection system 100 to leverage state-of-the-art natural language processing and understanding capabilities.

Through the inclusion of the large language model 60 provided by a third-party AI company, the system 100 benefits from ongoing advancements and updates offered by the AI service provider, ensuring access to the latest developments in language understanding and generation.

Furthermore, in order to tailor the large language model 60 to the specific requirements of telephone scam protection, the system 100 may employ customization techniques including retrieval-augmented generation (RAG) and fine-tuning. RAG enhances the AI module 120's ability to retrieve relevant information from a large knowledge base during conversation, thereby improving contextual awareness and response accuracy. This ensures that the AI, when interacting with a caller, can reference the most up-to-date and relevant information, which helps improve scam detection and protection. Fine-tuning involves adjusting the parameters of the large language model 60 using domain-specific datasets related to fraudulent activities, phishing patterns, and other deceptive techniques. By training the large language model 60 on specialized datasets, the system 100 enhances its ability to recognize subtle fraud indicators and accurately classify and respond to various fraudulent calls.

This customization process ensures that the AI module 120 maintains high performance in detecting and responding to emerging and complex scam strategies.

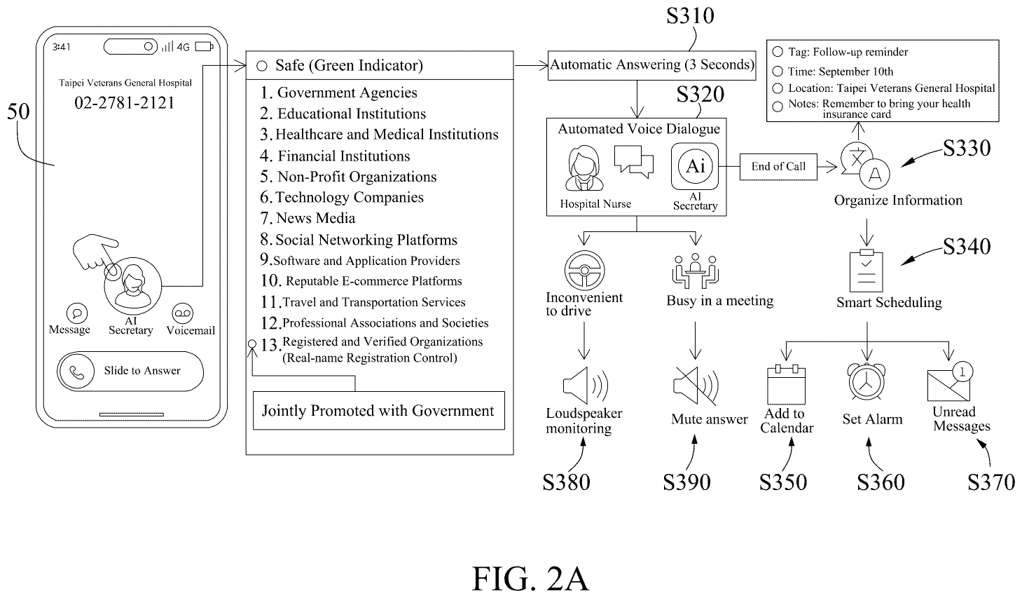

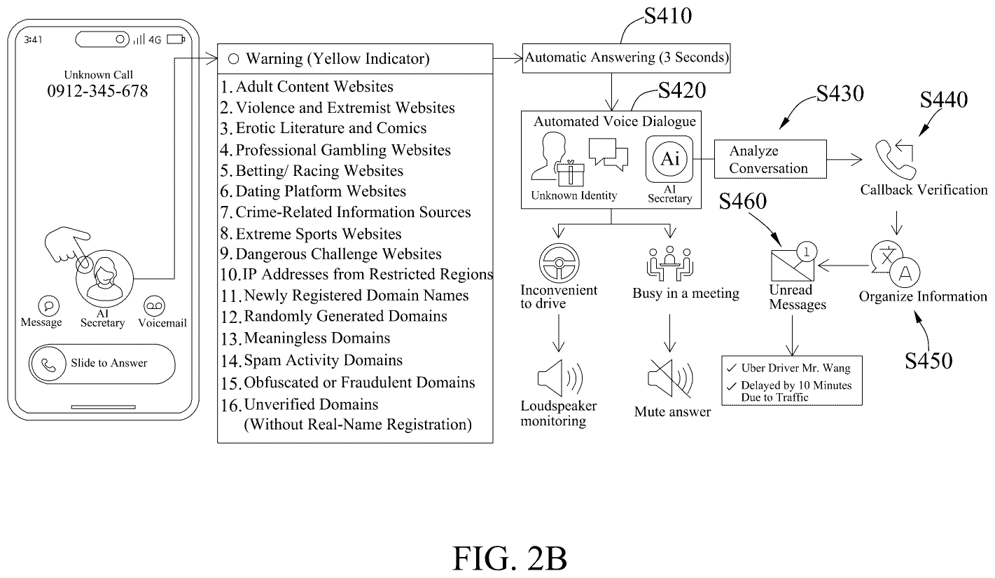

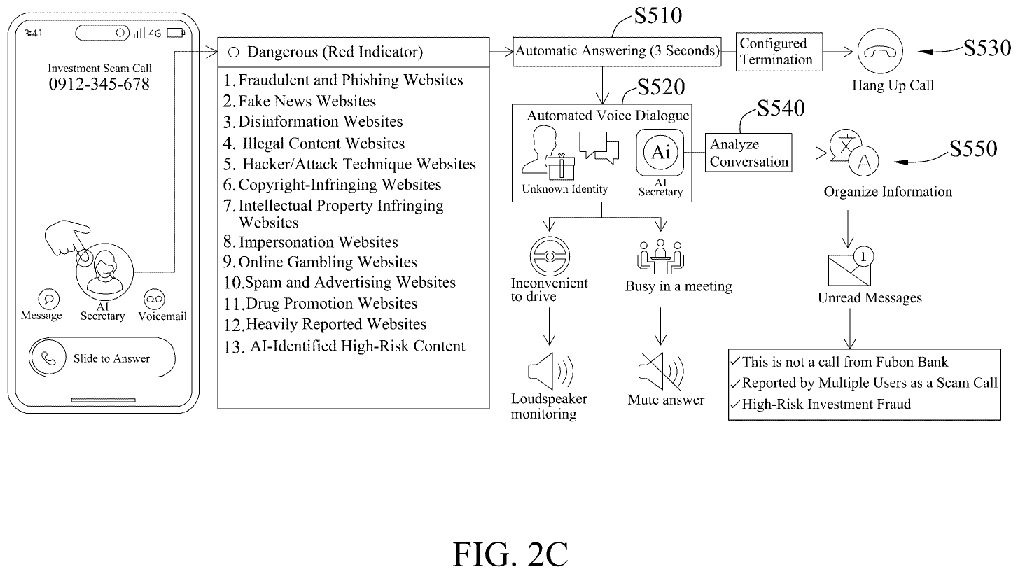

The telephone scam protection system 100 employs a risk-based classification mechanism to dynamically evaluate incoming calls and respond accordingly. Referring to FIG. 2A-2C, three representative scenarios are described below, corresponding to safe calls, suspicious calls, and dangerous calls.

Calls classified as safe are identified as legitimate communications from trusted institutions or routine reminders. These calls undergo real-time identity verification to ensure the authenticity of the caller 10. Once verified, the AI module 120 generates a concise conversation summary, stores the relevant information, and, through the integration module 150, automatically schedules related events in the user's calendar.

Referring to FIG. 2A, the smartphone interface 50 displays an incoming call from “Taipei Veterans General Hospital.” On the incoming call screen, an icon labeled “AI Secretary” (representing the AI module 120) is shown, indicating that if the user does not manually answer, the AI module 120 will automatically handle the call. On the right-hand side of FIG. 2A, after a three-second delay, the AI module 120 answers the call (Step S310) and begins conducting a conversation (Step S320). The figure illustrates an icon of a hospital nurse, showing that the AI module 120 can interact with real human callers (e.g., healthcare staff).

After the call, the system 100 organizes the conversation into a textual summary (Step S330), and, via intelligent scheduling (Step S340), automatically adds related events to the user's calendar (Step S350), sets reminders (Step S360), and manages unread messages (Step S370). Additional features shown in FIG. 2A include context-based adjustments such as hands-free listening (Step S380) and silent monitoring (Step S390) when the user is in an environment unsuitable for answering.

The telephone scam protection system 100 employs a traffic-light classification scheme, where green (safe) represents trusted entities, such as government agencies, educational institutions, medical institutions, financial institutions, non-profit organizations, technology companies, news media, social networking platforms, software and application providers, reputable e-commerce platforms, travel and transportation services, and professional associations. These entities may be recorded in a whitelist 142 stored in the data storage component 140, allowing the system 100 to quickly recognize them. An additional category of “registered and verified organizations” may also be jointly promoted with governmental authorities to further enhance call screening and scam protection.

Calls classified as suspicious exhibit inconsistencies or unverifiable information, and are flagged for further review. These interactions are recorded and stored for subsequent analysis, allowing manual review or additional verification to determine legitimacy.

Referring to FIG. 2B, the smartphone interface 50 displays an incoming call from an unknown number “0912-345-678” (for illustration only, not a real number). This number does not appear in either the whitelist 142 or the blacklist 144 of the data storage component 140. Similar to FIG. 2A, if the user does not manually answer, the AI module 120 automatically answers the call after three seconds (Step S410). After answering, the AI module 120 engages in dialogue with the unknown caller to attempt identity verification (Step S420). Since the caller's identity cannot be immediately verified, the system 100 flags the caller as “unknown.” The AI module 120 analyzes the conversation and detects potential anomalies or risks (Step S430). If unresolved, the call is classified as yellow (suspicious). The system may also initiate a callback (Step S440) to further verify the caller's authenticity.

After the call, the system generates a textual summary (Step S450). If the user has not listened to the conversation in real time, the information is stored as an unread message (Step S460). For instance, the summary may include details about an Uber driver informing the user of a ten-minute delay due to traffic congestion.

In FIG. 2B, the yellow classification is used to indicate potentially suspicious calls. Examples include calls originating from unverified or high-risk sources such as adult content websites, extremist websites, gambling sites, betting platforms, online dating platforms, criminal or law enforcement information sources, extreme sports websites, dangerous challenge websites, IP addresses from restricted regions, newly registered domain names, randomly generated domain names, meaningless or junk domains, obfuscated or scam-related domains, and unverified domains. The AI module 120 detects and classifies such calls, escalating them for user review or additional action if necessary.

Calls classified as dangerous are detected as containing fraudulent or phishing content, based on identification of sensitive keywords or malicious patterns that indicate fraudulent intent. The AI module 120 automatically terminates such calls to prevent potential harm. In addition, the system 100 blocks the caller's number and, via the integration module 150, reports the event to governmental authorities 30, thereby strengthening overall scam protection.

Referring to FIG. 2C, the smartphone interface displays an incoming call labeled “Investment Scam Call” with a number “0912-345-678” (for illustration only). As with the other scenarios, if the user does not manually answer, the AI module 120 automatically answers after three seconds (Step S510). During the conversation, the AI module 120 analyzes the content to detect potential fraudulent activity (Step S540). The call is classified as red (dangerous) based on the analysis. Alternatively, the system may automatically terminate the call immediately once it is identified as high-risk (Step S530).

In FIG. 2C, the red classification is used to mark dangerous calls, which may originate from phishing and scam websites, fake news websites, disinformation portals, illegal content websites, hacker forums, copyright-infringing platforms, fraudulent websites, online gambling sites, spam and advertising sources, drug promotion sites, heavily reported domains, or other high-risk entities listed in the blacklist 144 of the data storage component 140.

After the call, the AI module 120 analyzes and organizes the conversation into a textual summary (Step S550), notifying the user that the call has been flagged as dangerous. If the user has not listened to the call in real time, the message is stored in the data storage component 140 and marked as unread. The summary may include contextual notes, such as “This is not a call from Fubon Bank,” “Reported by multiple users as a scam,” or “High-risk investment fraud.” If explicit fraud activity is detected, the system 100 may automatically terminate the call or block further interactions with the number, thereby protecting the user from harm.

Further details of the AI module 120 are provided below. In this embodiment, the AI module 120 utilizes natural language processing, semantic analysis, image recognition, and optical character recognition (OCR) to interpret and understand conversation content. The AI module 120 conducts meaningful dialogue with the caller 10 by asking relevant questions to verify the caller's identity and intent. Through NLP and semantic analysis, the AI module 120 discerns context and nuances to detect irregular or suspicious patterns that may indicate fraudulent intent. By analyzing scam-related keywords and conversational patterns—such as references to “money,” “bank accounts,” or urgent requests for personal information—the AI module 120 identifies potential threats. The fraud-detection algorithms of the AI module 120 are continually updated based on new data and emerging scam tactics to maintain adaptability and effectiveness.

During the conversation, when the caller 10 mentions any URL or website, the AI module 120 checks such references against a blacklist 144 and may perform real-time phishing assessment to evaluate the legitimacy of the referenced online resources. This proactive verification prevents the user from inadvertently visiting malicious websites. Unlike conventional caller-ID or call-blocking services that rely solely on static databases, the system actively engages in dialogue to verify the caller's legitimacy, thereby providing a more robust and dynamic detection mechanism capable of identifying sophisticated or novel scams that may bypass traditional filters.

Upon call termination, the system generates a concise textual summary containing key details of the conversation, allowing the user to review important information without listening to long recordings. The AI module 120 intelligently extracts actionable items—such as appointment times and dates—from the dialogue. The integration module 150 then automatically creates corresponding events in the user's calendar or sends notifications via messaging services. Users may configure the integration module 150 to prioritize specific data types or designate preferred external services.

The integration module 150 is designed for versatility and supports APIs of various calendar and messaging services, including but not limited to Google Calendar and Microsoft Outlook. Alternatively, the integration module 150 may configure the built-in alarm of the user's smartphone to serve as a subsequent reminder.

Security and privacy are fundamental to the design of the system 100. Multi-layer protection mechanisms safeguard sensitive information, and strong encryption protocols protect processed data throughout call analysis and storage. The data storage component 140 securely stores conversation summaries, classification data, and records of suspicious or dangerous calls, ensuring compliance with applicable data-protection regulations.

Through the user intervention interface 160, the user may monitor ongoing conversations in real time via a hands-free device and, when necessary, override actions taken by the AI module 120 or directly take control of the call. For example, if the user recognizes the caller during a call classified as “suspicious” or “dangerous,” the user may choose to continue the conversation and take alternative actions.

The fraud-detection performance of the system 100 is maintained by robust learning and update mechanisms. The AI module 120 incorporates machine-learning algorithms that analyze past interactions and user feedback to refine detection parameters. The system can also integrate with external threat-intelligence sources 40 to ingest the latest scam tactics and incorporate them into the detection algorithms, while continuously training on recent data and patterns.

The architecture of the system 100 is designed for scalability—from individual users to large enterprises—through modular design and efficient resource management. The system ensures compatibility across diverse telecommunication systems and devices, whether integrated into personal smartphones or enterprise platforms. Low latency is required for real-time call handling and fraud detection; optimized algorithms and efficient processing ensure prompt responses. The user intervention interface 160 is intuitive and easy to operate, with clear visual indicators and straightforward controls. Strong security protocols are employed to protect data integrity and prevent unauthorized access.

Compared with existing solutions, the system 100 offers several innovative advantages: (i) proactive engagement—AI interacts with the caller in real time to verify legitimacy; (ii) continuous learning and adaptability—algorithms evolve with user feedback and new threats; (iii) user-centric control—real-time monitoring and manual override; (iv) tight integration with calendars and messaging platforms for unified user experience; and (v) strong security measures including encryption and secure storage to protect sensitive information.

Various modifications may be implemented without departing from the spirit and scope of the invention. Examples include alternative risk-classification schemes tailored to specific user needs or emerging scam patterns; enhanced verification methods such as biometrics or multi-factor authentication; and broader integrations with external services such as customer-relationship-management (CRM) systems, enterprise-resource-planning (ERP) platforms, and other organizational tools.

User-adjustable settings may be provided to tune system sensitivity, response actions, and integration preferences. Multi-language support can be implemented to increase applicability across different regions and user groups.

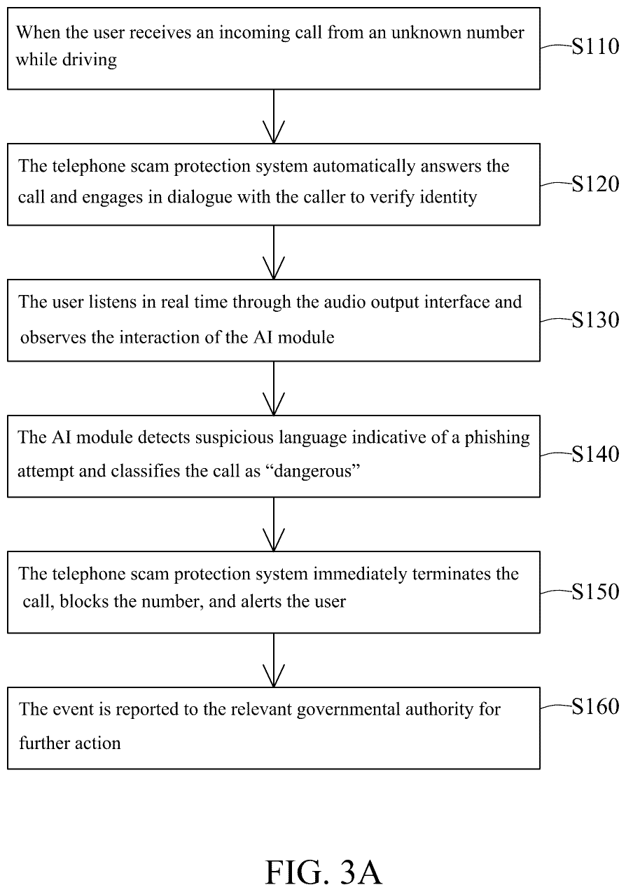

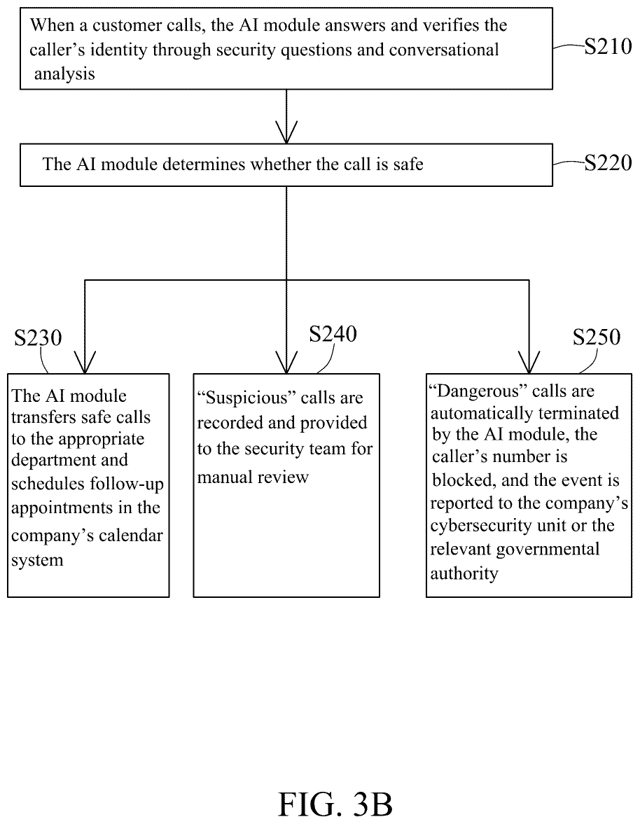

To further illustrate the functionality and applications of the telephone scam protection system 100, exemplary operating procedures in different usage scenarios are described with reference to FIGS. 3A and 3B.

Referring to FIG. 3A, a flowchart of the operating procedure of the telephone scam protection system 100 in a personal-use scenario is shown.

In Step S110, while driving, a user receives an incoming call from an unknown number.

In Step S120, the telephone scam protection system 100 automatically answers the call and engages in dialogue with the caller 10 to verify the caller's identity. Simultaneously, the user listens in real time via the audio output interface 130 to observe the interaction of the AI module 120.

In Step S140, during the conversation, the AI module 120 detects suspicious language indicating a phishing attempt and classifies the call as “dangerous.”

In Step S150, the telephone scam protection system 100 immediately terminates the call, blocks the number, and alerts the user of the scam attempt.

In Step S160, the event is reported to the relevant governmental authority 30 for further action.

This process enables the user to remain protected in real time, even when unable to answer the call directly.

Referring to FIG. 3B, a flowchart of the operating procedure of the telephone scam protection system 100 in an enterprise-use scenario is shown.

In Step S210, when a customer places a call to the company's hotline, the AI module 120 answers the call and verifies the caller's identity through a series of security questions and conversational analysis.

In Step S220, the AI module 120 determines whether the call is safe.

If the call is deemed safe, in Step S230, the AI module 120 transfers the call to the appropriate department and arranges follow-up appointments within the company's calendar system.

If the call is deemed suspicious, in Step S240, the interaction is recorded by the AI module 120 and stored for manual review by the company's security team.

If the call is deemed dangerous, in Step S250, the AI module 120 automatically terminates the call, blocks the caller 10, and reports the event to the company's cybersecurity unit and/or relevant governmental authorities.

In multi-platform integration scenarios, the user accesses the telephone scam protection system 100 through multiple devices, including smartphones, tablets, and desktop computers. The integration module 150 synchronizes conversation summaries and calendar events across all devices, ensuring that the user can consistently access call information and scheduled events regardless of device. This seamless integration enhances user convenience and ensures that important information remains accessible across platforms.

While the invention has been disclosed through preferred embodiments, the scope of the invention is not limited thereby. Equivalent modifications and variations made by those skilled in the art without departing from the spirit and scope of the invention are intended to be encompassed by the appended claims.

What is claimed is:

1. A telephone scam protection system, comprising:
a communication interface configured to receive and transmit telephone calls;
an artificial intelligence (AI) module configured to:
automatically answer an incoming call on behalf of a user when the user is unavailable to answer or when a caller is unidentified;
conduct a real-time conversation with the caller using natural language processing and semantic analysis to verify the caller's identity and evaluate the legitimacy of the call;
analyze the content of the conversation in real time to detect potential fraudulent activities by identifying suspicious keywords or patterns associated with scams;
classify the telephone call into one of a plurality of risk categories based on an analysis result, the risk categories including at least safe, suspicious, and dangerous;
automatically terminate the call, block the caller's number, and report the event to governmental authorities when the call is classified as dangerous;
perform real-time phishing assessment of any web links or URLs provided by the caller during the conversation, and compare the links against a stored blacklist of malicious websites to identify phishing attempts;
analyze any visual content provided by the caller during the conversation using image recognition and optical character recognition (OCR) techniques; and
continuously update fraud detection algorithm parameters based on previous call interaction records and data from external threat intelligence sources;
an audio output interface configured to allow the user to monitor an ongoing conversation in real time;
a user intervention interface configured to allow the user to intervene in and control the telephone call and override actions taken by the AI module;
a data storage component configured to store, in encrypted form, conversation summaries, classification data, and records of suspicious or dangerous calls; and
an integration module configured to extract relevant information from the conversation and integrate the information into external services including calendars and messaging platforms, automatically scheduling events in the user's calendar and transmitting corresponding notifications through the messaging platform.

2. The telephone scam protection system of claim 1, wherein the artificial intelligence module is configured to support conversations and analysis in multiple languages.
